(19) United States
(12) Patent Application Publication
(10) Pub. No.: US 2005/0222889 A1
(43) Pub. Date: Oct. 6, 2005

(54) Method and system for facility management

(76) Inventors: Chris Lai, Naperville, IL (US); Steven Philip Daniels, Buffalo Grove, IL (US)

Correspondence Address: JENNER & BLOCK, LLP, ONE IBM PLAZA, CHICAGO, IL, 60611, US

(21) Appl. No.: 10/815,205

(22) Filed: Mar. 31, 2004

(51) Int. Cl. G06F 17/60

(52) U.S. Cl. 705/9

(57) ABSTRACT

The present invention relates generally to computer systems for performing facility management tasks, and in particular to a method and system for providing improved computerized inspection tools, improved work order management tools, and integration of these tools with computer systems for performing other facility management tasks, including staff management, equipment automation, security, billing and inventory. Among other things, the improved computerized inspection tools provide efficient data aggregation and reporting.

### FIELD OF THE INVENTION

The present invention relates generally to computer systems for performing facility management tasks, and in particular to a method and system for providing improved computerized inspection tools, improved work order management tools, and integration of these tools with computer systems for performing other facility management tasks, including staff management, equipment automation, security, billing and inventory. Among other things, the improved computerized inspection tools provide efficient data aggregation and reporting.

### BACKGROUND OF THE INVENTION

Managing a commercial facility is expensive, time-consuming and requires management personnel to perform and monitor a variety of tasks. Such tasks include inspecting the facility for problems, repairing the problems, managing personnel and facility security, coordinating events, and managing automated equipment, inventory and billing. Currently such tasks are performed using a variety of different, incompatible approaches. These approaches include entering information on paper-based forms, as well as some computer systems. Existing computer systems, however, are generally limited to performing specific facility management tasks and do not provide an integrated set of tools. Such existing systems have separate data structures for describing the specific tasks and therefore are not able to communicate information electronically with other systems and require duplication of effort. This is undesirable.

The most expensive part of managing any kind of property, particularly a commercial facility, is providing maintenance and engineering services. Facility management companies and departments are continually looking for ways to satisfy their clients' demand for clean, well-maintained facilities for the lowest possible cost. Facility management organizations need a thorough, objective way to monitor and evaluate performance to be able to show clients and tenants that they are succeeding in controlling costs.

The process of verifying that a facility is clean and well maintained is known as “quality assurance.” Inspectors review a facility for defective or unsanitary conditions. Traditionally, the results of inspections are recorded on paper-based forms, which have several drawbacks. Paper-based forms can be lost or damaged; tracking performance, such as reporting the number of defects over time, is extremely difficult with paper-based forms; and existing paper-based forms do not allow defects to be easily categorized or compared for different types of rooms. This is undesirable, particularly with regard to large, multi-building commercial facilities.

Most paper-based forms are too general, merely indicating that a room is acceptable or unacceptable and allowing an inspector to write an explanation. Such general forms require inspectors to make broad, subjective evaluations that cannot be easily categorized or compared. The remaining paper-based forms are overly specific and present detailed checklists of items for each different type of room. In such systems, the checklist for inspecting a bathroom is a different form than the checklist for inspecting a conference room. Such paper-based checklists do not provide standard terms and values across different types of facilities or different types of rooms within a facility.

One existing paper-based system allows inspectors to enter objective values across different types of managed facilities or rooms being inspected, but does not provide for the objective values to be weighted to determine an overall score for a room or across all of the rooms for a facility. This is undesirable because values for one type of room in a facility may be more important than other rooms. Also, one particular high-traffic room may be more important than low traffic rooms of the same type. Without weighting, the objective values for an executive office are treated the same as the values for a coat closet. This system also shares the disadvantages of other paper based systems, such as loss and damage, and because entries are handwritten, any use of the data requires manual correlation and searching.

Some of the disadvantages of paper-based systems are eliminated by recording inspection results in electronic databases. In this case, the inspector records information on paper-based forms and enters the results manually into a computer system. Unfortunately, even in these systems, the paper forms are still subject to loss and damage. Entering the information into the computer system also requires costly duplication of effort and allows for data entry errors. This is undesirable.

Computerized quality assurance systems eliminate paper-based forms and provide limited functionality to electronically record inspection results. Such systems allow an inspector to carry a personal digital assistant (“PDA”) and essentially duplicate paper-based forms on the PDA. While reducing the risks of loss and damage associated with paper forms, to the extent they duplicate paper-based forms, such systems still suffer from the functional limitations of paper forms discussed above. In particular, the computerized form is either too general, too specific, or lacks features that allow comparisons between different types of rooms and facilities. Also, these systems do not effectively integrate with other property management systems such as work order systems. Where detailed textual descriptions are required, e.g., for the most general forms, these descriptions are difficult to enter on existing PDAs and are not easily categorized or searched. None of the computerized systems known in the art disclose a set of objective values applicable across different types of rooms and facilities having weights to compare the values.

Managing a modern commercial facility also requires management of the work order process to repair problems. For example, once an inspector identifies a defective condition, a request for the condition to be repaired (also known as a “work order”) must be submitted to the building maintenance or custodial department. Such work orders must then be assigned to appropriate personnel to be performed. Computerized work order systems are known in the art, but are not integrated with other facility management systems such as staff management systems, inspection systems, or preventative maintenance systems. Such lack of integration requires duplicated effort and manual data entry, leading to additional opportunities for errors. U.S. patent application Ser. No. 09/938,265 to Thielges et al. describes a computerized work order system where building tenants enter incident reports into a networked computer system. Although Thielges provides for tracking of entered incident reports, the requirement for manual entry of incident reports means that repairs may be accidentally entered for the wrong building or floor, or repair requests may never be entered at all. This is undesirable.

Existing work order systems require work orders to be manually assigned to maintenance personnel, and do not automatically account for vacations or other absences. This is undesirable and may lead to delays in performing urgent repairs. Existing work order systems also deliver work orders to the field via text messaging or e-mail, but e-mail and text messaging limits what can be communicated back to the system. Users are often forced to type in text responses, as opposed to selecting responses from a list, which can lead to errors and makes standardization difficult. Some existing work order systems avoid this by using text messaging capability to allow the user to respond with a small number of preset options.

In light of the shortcomings discussed above, a need exists for an integrated facility management system that allows individual components to communicate using common data structures. A need further exists for a computerized quality assurance system that provides for electronic entry of inspection information and comparison between different inspection targets using objective values and weights. A need further exists for a work order system that is integrated with a staff management system in order to automatically route and monitor work orders based on personnel information.

### SUMMARY OF THE INVENTION

In accordance with one aspect of the present invention, an integrated facility management system is provided. Individual applications for performing specific facility management tasks are integrated and share a common central computer system having a database. This allows data from one application to be efficiently used by the other applications. The integrated applications preferably include quality assurance and work order systems. Other aspects of the integrated facility management system of the present invention include other applications such as inventory management, billing, events planning, automated equipment management and security systems. Applications on the central computer system are preferably accessible using a web browser over any computer connected to the Internet. Although the integrated facility management system of the present invention preferably includes multiple integrated applications, the individual applications of the present invention are operable without the other applications and include novel aspects as described below.

In another aspect of the present invention, a computerized quality assurance system is provided to facilitate inspection services and the aggregation of inspection data for reporting and comparison purposes. Accordingly, inspection information is entered into a portable inspection device such as a personal digital assistant (“PDA”). The inspection device transmits the inspection information from the PDA to the central computer system for storage in the central database. The inspection information is preferably accessible on the central computer system over the Internet from any computer using a web browser. A reporting application for analyzing the inspection information is preferably accessible on the central computer system over the Internet using a web browser. The reporting application provides information grouped in various customizable formats.

The inspection information includes inspection functions with objective values that define the inspection score for the target of the inspection. The scores for inspection functions are weighted to compute an overall inspection score for each target. This allows direct comparisons to be made between different targets. In order to accurately compare targets of different types, the weights for each inspection function can be set differently for each type of inspection target. Inspection information also includes common deficiencies applicable to different types of targets.

In the embodiment of this invention used to inspect facilities, the inspection targets are physical locations within the facilities. These locations include different types of rooms, such as restrooms, conference rooms and offices. In one embodiment of the invention, the inspection functions are used to score and compare the cleanliness of the different physical locations. The inspection functions for cleanliness preferably include the condition of the trash, spot clean, corner detail, glass, fixtures, re-supply, dust, corners, carpet and hard floor for each location. The “trash” inspection function is equally applicable to a restroom location and a conference room location, but the “carpet” inspection function may not have a corollary for a restroom location. Overall scores are calculated for each location, where each inspection function applicable to that location has its own weight in the overall location score. Overall scores for each facility are calculated using the overall location scores for each location in the facility with each location having additional weighting factors including the type of location, location size and location priority or traffic.

Inspection information is customized for any particular installation of the quality assurance system. In other words, the inspection information that should be entered for a particular location is determined on a case-by-case basis.

Inspection information is preferably entered into the inspection device using drop down lists. Drop down lists minimize data entry errors. Inspection information is preferably categorized for electronic aggregation and comparison purposes, and such categories are stored in a central database on the central computer system.

In another aspect of the present invention, the quality assurance system includes a staff management component for associating personnel with targets or types of targets being inspected. The staff management component allows personnel performance to be tracked using the results of the inspection.

In yet another aspect of the present invention, a computerized work order system is provided for requesting repairs and tracking repair requests for common deficiencies. The computerized work order system includes a staff management component. This integration allows work orders to be automatically assigned to the appropriate person for the repair, taking into account the availability and specialty of repair personnel as determined by the staff management component.

In yet another aspect of the present invention, the quality assurance system is integrated with the work order system. This allows an inspector to electronically generate work orders for a target based on the inspection information for the target. The quality assurance system and work order system share the common central database and data structures, which allows the systems to communicate.

### BRIEF DESCRIPTION OF THE DRAWINGS

FIG. 1 is a block diagram of an embodiment of a quality assurance system in accordance with the present invention.

FIG. 2 is a flow chart illustrating operation of a quality assurance system in accordance with the present invention.

FIG. 3 is a block diagram of an integrated property management system in accordance with the present invention.

FIG. 4 is a flow chart illustrating operation of a work order system in accordance with an integrated property management system of the present invention.

FIG. 5 is a block diagram of an embodiment of a work order system integrated with other facility management systems.

FIG. 6 is a block diagram of software components of the quality assurance system of FIG. 1.

FIG. 7 illustrates a user interface for entering inspection functions for the quality assurance system of FIG. 1.

FIG. 8 is an illustration of a user interface for entering deficiencies for the quality assurance system of FIG. 1.

### DETAILED DESCRIPTION OF THE INVENTION

One embodiment of an integrated facility management system in accordance with the present invention provides applications for performing facility management tasks. The applications share a common central computer system and central database, with common data structures for electronically communicating information between applications. The set of applications preferably includes a quality assurance system and a work order system. Other embodiments of the present invention include other facility management applications as described in more detail below. Although the facility management system of the present invention preferably includes multiple integrated applications, the individual applications of the present invention are operable without the other applications and also include novel aspects. The individual applications of the integrated facility management are described in more detail below. The applications are preferably accessible over the Internet from any computer using a web browser. This allows users of the applications, including building managers, staff and tenants, to view the status of ongoing activities, report on past activities and interact with the applications remotely.

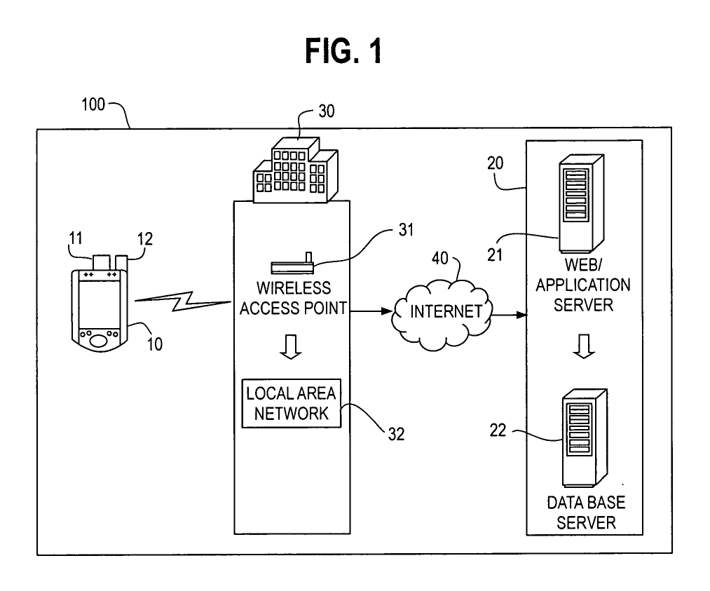

FIG. 1 shows an embodiment of a quality assurance system 100 in accordance with the present invention. Although quality assurance system 100 is described in the context of performing inspections within a managed facility, other embodiments can be used to inspect anything capable of being inspected, referred to as an inspection target. The inspection targets for quality assurance system 100 are locations within the facility, such as particular rooms or groups of rooms. In alternative embodiments, inspection targets can be specific items within those locations.

Quality assurance system 100 includes a portable inspection device 10 and a central computer system 20. Central computer system 20 includes an application server 21 and a central database 22. Inspectors use inspection device 10 to enter inspection information about the inspection targets, which is transmitted to the central computer system 20. Once the inspection information is stored on central computer system 20, the inspection information can be accessed for multiple purposes anywhere over Internet 40, as described in more detail below.

Inspection device 10 is preferably a PDA such as a PalmPilot, RIM Blackberry or Microsoft PocketPC device or any similar portable computer system such as a laptop, notebook computer or mobile phone capable of executing computer programs. Inspection device 10 includes local electronic storage 11, which is preferably a flash memory card, such as a Secure Digital card. Alternatively, local electronic storage 11 is a hard disk, floppy disk or writable compact disc. Inspection device 10 preferably includes a digital camera 12 for taking pictures of locations and defective conditions. The inspection device 10 executes quality assurance software that allows an inspector to enter inspection information about the inspection targets, e.g., furniture, room, wall, etc., being inspected. The inspection device 10 has a communications interface for transmitting electronic communications, including inspection information, to central computer system 20 via wireless access point 30, local area network 31 and Internet 40, as described below. The communications interface is preferably a wireless communications technology such as Wireless Fidelity (“Wi-Fi”). Wi-Fi uses the Institute of Electrical and Electronic Engineers (“IEEE”) 802.11 family of wireless standards, including 802.11, 802.11a, 802.11b, and 802.11 g. Alternative embodiments use other wireless communications methods, such as cellular or mobile radio communications systems.

Inspection device 10 executes quality assurance software that preferably resides on inspection device 10. In alternative embodiments of the invention, quality assurance software resides on application server 21 and is accessed as a web application on inspection device 10 using a web browser. The quality assurance software preferably includes a local database for maintaining inspection records using local electronic storage 11. The local database contains tables or subsets of tables synchronized from central database 22. The tables or subsets of tables include, for example, the list of inspection targets, inspection target types and associated types of inspection information.

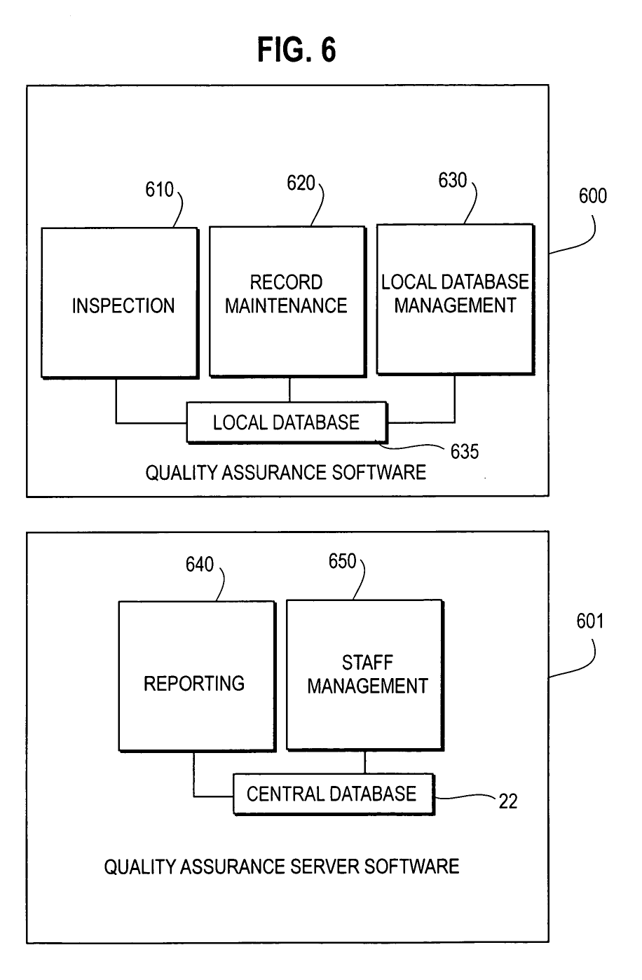

FIG. 6 illustrates software components of the quality assurance system 100. Quality assurance software 600 executes on inspection device 10. Quality assurance software 600 includes an inspection component 610 for performing inspections, a record maintenance component 620 for querying inspection records, and a local database manager component 630 for performing database management tasks on the local database 635. Quality assurance software 600 provides a login mechanism, such as entering a username and password, to ensure security and to allow different inspectors to see different information or inspect locations or types of locations. The username is preferably selected from a drop down list. Quality assurance software 600 preferably uses electronic forms for entering data using drop-down list boxes to avoid data entry errors. A drop-down list box is a software user interface element that presents the user with a list of all available choices for a particular field and allows the user to select one or more of the choices. The list of available choices for a drop-down list box is preferably stored in local database 635.

Inspection component 610 of the quality assurance software 600 provides a user interface to record information regarding an inspection. Quality assurance software 600 provides a list of available locations, as well as the appropriate inspection information fields for the selected location. Inspection information includes inspection functions. Each inspection function allows an inspector to provide an objective value regarding a particular attribute of the inspection target being inspected, or a particular task to be performed on the inspection target. The attributes or tasks are generally applicable across different types of inspection targets to be inspected. Quality assurance software 600 allows entry of a numeric value for each inspection function applicable to the selected inspection target. Quality assurance software 600 is also configurable to associate different weights to each inspection function to calculate an overall inspection target score. Inspection function weights are configurable for each type of inspection target, depending on which inspection target attribute is the most important. Additional weights are configurable for each inspection target, such as by assigning each inspection target a priority.

Inspection information for an inspection target also includes deficiencies frequently encountered for the type of selected inspection target. Deficiencies are organized by category and sub-category to enable quicker data entry. The local database also includes a list of common tasks associated with each sub-category. The user associates zero or more deficiencies with an inspection target, and assigns a priority to each deficiency. The quality assurance software 600 also provides functionality to view, edit and delete deficiencies. For example, after the inspector has finished inspecting an inspection target, the inspector can review the list of entered deficiencies and edit for any errors. The inspector can also reconsider the priority assigned to each deficiency, and either increase or decrease the priority.

Inspection information also can include a more detailed textual description of the selected inspection target. That is, text, in addition to the inspection functions and deficiencies, may be entered and included as inspection information.

Inspection information for an inspection target is stored in the local database 635 on electronic storage 11 as an inspection record. Each inspection record, in addition to the inspection information, can also contain one or more pictures illustrating the inspection target being inspected. Preferably, the quality assurance software operates digital camera 12 to take and store one or more pictures of an inspection target in the local database 635. Each picture is associated with the inspection information for an inspection target. The quality assurance software 600 allows the user to select the picture title from a list of common descriptions or manually type in a description. The quality assurance software also provides functionality to delete and move pictures. A user may also partially complete an inspection for an inspection target and mark the inspection record as “open” for later review.

Record maintenance component 620 of quality assurance software 600 provides functionality for maintaining inspection records in the local database 635. Record maintenance component 620 allows the user to query records by date range, as well as view, edit and delete records. Record maintenance component 620 also provides functionality for copying and pasting inspection information from one record to another.

Local database manager component 630 includes synchronization functionality for synchronizing inspection records on the local database 635 with central computer system 20. Quality assurance software 600 is configurable to transmit inspection records to central computer system individually, when a certain number of inspection records have been entered, or when the user manually requests a synchronization. The database manager component also provides functionality to rebuild, compact, backup and recover the local database by connecting to central database 21.

Referring again to FIG. 1, application server 21 on central computer system 20 operates a web server and other applications described in more detail below such as reporting utilities and data entry applications. Application server 21 operates on Microsoft Windows 2000 or another server operating system such as UNIX or Linux and preferably includes a web server such as Microsoft Internet Information Services. Alternative embodiments use other known web servers such as Netscape or BEA WebLogic. Application server 21 allows quality assurance server applications to be accessed anywhere over a computer connected to Internet 40.

FIG. 6 shows quality assurance server software 601. Quality assurance server software 601 executes on application server 21. Quality assurance server software 601 includes a reporting component 640 and a staff management component 650. Reporting component 640 includes reporting applications to provide graphs and reports regarding the inspection information. Reporting applications are accessed on application server 21 using any computer with a web browser over Internet 40. Reporting applications read inspection information from database 22. One preferred embodiment of the present invention uses Dundas Chart graphing software from Dundas Software, Inc. of Toronto, Ontario. Reports are provided including reports regarding inspection functions or deficiencies, problem areas, and inspection target type. Reports are also provided for history and trends of inspection function values. Reports are also provided for tracking performance of staff in correlation with inspection function information and deficiencies. The reporting applications allow users to customize reports.

Quality assurance server software 601 also includes a staff management component 650 that is accessible over Internet 40 using a web browser. Personnel records used by the staff management component 650 are stored in central database 22. Staff management component 650 provides applications for entering and modifying personnel records. In alternative embodiments, personnel records are loaded from a human resources system such as PeopleSoft. The staff management component 650 preferably stores information about the training, background, and experience of each employee. The staff management component 650 also recommends training programs and tracks reviews, attendance, tardiness, and disciplinary actions. Personnel are assigned specific roles and are associated with specific inspection targets and/or inspection target types.

Referring again to FIG. 1, central database 22 preferably includes a relational database such Microsoft SQL Server, Sybase or Oracle operating on a database server. Alternative embodiments use other standard data storage mechanisms in place of a relational database, including object databases, indexed files, or flat files. Although database 22 is shown operating on a separate computer from application server 21, all components of central computer system 20 may be resident on one computer, or on more than one computer. Database 22 stores the list of inspection targets and types of inspection targets to be inspected, as well as the list of common defects associated with each type of inspection target. Such defects are referred to as deficiencies. Database 22 also contains the inspection functions associated with each type of inspection target, as well as weighting functions for determining which inspection function has the largest effect. Database 22 also contains personnel records for users such as inspectors using the inspection device 10. Users can be associated with particular inspection targets and types of inspection targets, and particular categories and subcategories of deficiencies. Personnel records also exist for other personnel associated with inspection targets, such as the person having primary responsibility for an inspection target.

FIG. 1 shows an embodiment of quality assurance system 100 for inspecting commercial property facilities. Quality assurance system 100 provides quality assurance functionality for inspecting any size facility, from a single small office building to an enterprise with multiple offices and warehouses on different continents and for storing the information in a central database for reporting and comparison purposes. In the preferred embodiment, facilities are divided into buildings, floors and rooms, although other organizational schemes are alternatively used. A location represents a specific area to be inspected and may represent an individual room or area or a specific group of rooms or areas within a facility. For example, the tenth floor in an office building could have three locations, a rest room location, a hallway location, and an office location. The rest room location could be defined to include four rest rooms on the floor, while the office location could include a row of eight offices against the south wall of the building. The embodiment shown in FIG. 1 shows a facility having one building 30 to be managed.

In operation, an inspector walks through one or more locations in building 30 carrying inspection device 10. The inspector initially logs in to the quality assurance software 600 executing on inspection device 10. The quality assurance software loads information about the facility being inspected from database 22, including the list of locations for which the inspector has been assigned responsibility, the list of applicable inspection functions, and the list of categories, subcategories and common defects applicable to the inspector.

When the inspector inspects a location, the inspector selects the location from a drop-down list. The inspection component 610 of the quality assurance software 600 allows the inspector to enter inspection information applicable to the location type. Inspection information includes inspection functions as well as specific deficiencies. The quality assurance software 600 also allows the inspector to take pictures of a location and enter text comments to further describe particular problems.

In accordance with the present invention, objective values are assigned to inspection functions and therefore allow different location types to be compared. Table I lists inspection functions for judging one aspect of facility management, the cleanliness of locations in a facility.

TABLE I

| Inspection Function | Description |
|---|---|
| Trash | Examine the amount of trash in trash can and on the floor. |
| Spot clean | Examine all surfaces (doors, walls, tabletop, etc . . . , excluding |
| | floors) for finger marks, stains and marks in general. |
| Corner detail | Examine the corners of floors and walls, hidden areas (behind |
| | doors and underneath furniture) and around edges of objects for |
| | build up. |
| Glass | Examine all mirrors and glass panels (i.e. glass door, glass |
| | partition wall and restroom mirrors) for neglect, streaks, water |
| | marks and damage from improper cleaning technique. |
| Furniture | Examine furniture condition. Look for dirty buildup and stains |
| | in seat cracks and top surfaces. |
| Re-supply | Check the level of supply of tissue paper, paper towel and soap in |
| | dispensers. |
| Fixtures | Examine faucets, sinks, water fountains, toilets, urinals, |
| | bathroom stall walls, kitchen appliances and stainless steel |
| | receptacles. |
| Dust | Examine high, low, horizontal and vertical dusting. Pay |
| | particular attention to air vents. |
| Carpet | Examine carpet condition. Check if it's been vacuumed, check |
| | for spots and dirt buildup. |
| Hard floor | Examine all hard floor surfaces (i.e. tile, terrazzo, hardwood, |
| | and marble). |

In a preferred embodiment, the inspector assesses the inspection functions of each location and assigns a value from 1 to 10 for each inspection function, where 10 is Superior, 9 is Excellent, 8 is High Satisfactory, 7 is Satisfactory, 6 is Low Satisfactory, and 1-5 is Unacceptable.

In accordance with the invention, inspection function values are preferably weighted using a weighting function stored in central database 22 to provide an overall location score. This facilitates objective determination and comparison of the cleanliness of a location or the overall cleanliness of one or more buildings. The weights assigned to each inspection function are customizable for each location type. For example, carpet cleaning takes more effort than taking out the trash, so a value of 9 on carpet in a location may be more important for an overall location value than a value of 10 for trash. The overall location score for a location is also affected by weights specific to that location, including the size and priority of the location. A value for a clean restroom in a high-traffic building lobby typically has a greater weight than a value for a restroom in the corner of a storage area, because the lobby restroom is used more heavily. The weighting function also takes into account whether a value has been entered for an inspection function for the location when calculating the overall location score. For example, if the “carpet” inspection function is not applicable to a restroom location or has not been entered, the overall location score weights are adjusted accordingly.

An overall score for a facility is calculated by taking into account the overall scores for each location in the facility. Where a facility includes multiple buildings, an overall score for each building is calculated by taking into account the overall scores for each location in each building. Each facility will have a custom set of inspection functions and associated weights stored in the quality assurance software and database 22.

One example of a function for calculating an overall score for a location based on the weighted average of the inspection functions for judging the cleanliness of the location is provided below. Only non-zero inspection functions are included:

$${S}_{L} = \frac{{\sum }_{F} {S}_{FL} {W}_{FL}}{\sum {W}_{FL}}$$

where:
S_{L}=Score of Location
S_{FL}=Score of the inspection function F in location L that is not zero
W_{FL}=Weight of the inspection function F by the location type of location L
ΣW_{FL}=Sum of all W_{FL}

Once the overall score for each of the locations in a building has been calculated, an overall score for a building is calculated based on the weighted average of the score for each location in the building:

$${W}_{L} = \frac{{Q}_{L} {R}_{L} {T}_{L}}{\sum {Q}_{R}}$$

where:
W_{L}=Weight of location L
Q_{L}=Square Feet of location L
R_{L}=Factor of the room type of location L
T_{L}=Traffic/Priority factor of location L
ΣQ_{R}=The sum of square feet for all locations with the same room type as L

$${S}_{B} = \frac{{\sum }_{L} {S}_{LB} {W}_{LB}}{\sum W}$$

where:
S_{B}=Score of building B
S_{LB}=S_{L} for building B
W_{LB}=W_{L} for building B
ΣW=Sum of all W_{LB}

Although the inspection functions listed above illustrate one embodiment for scoring the cleanliness of a facility, alternative embodiments include inspection functions for other kinds of inspections, such as energy efficiency. Inspection functions for energy efficiency for a facility include light bulbs, heating and air conditioning systems and other equipment to create a value to show how much energy is required for each location in a facility. For any application requiring inspection, a set of inspection functions, values and weights are stored in database 22.

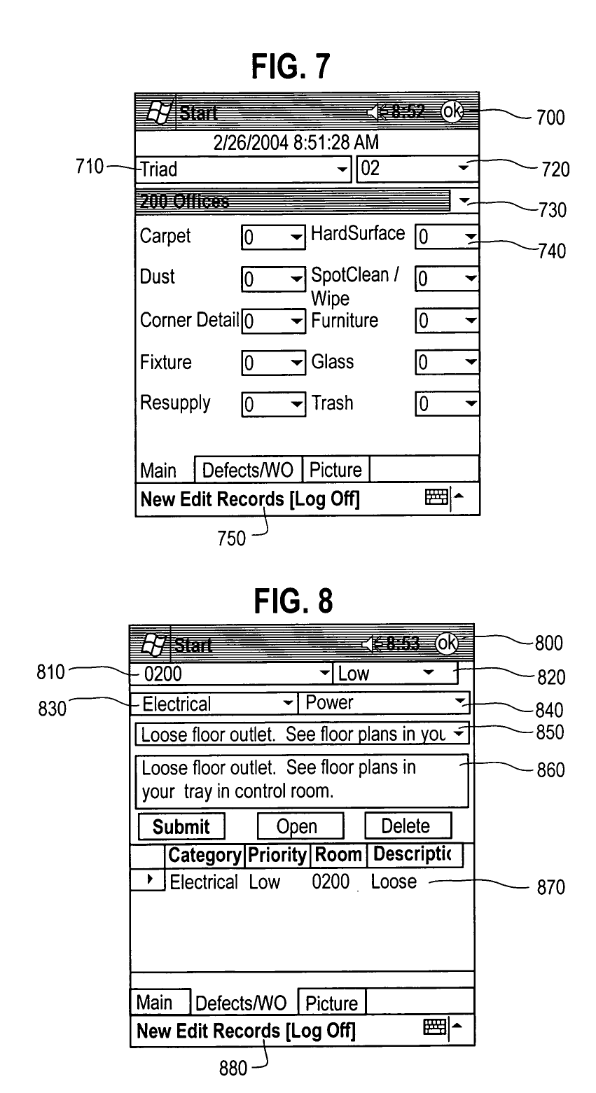

FIG. 7 is an exemplary screen shot of a user interface for entering values for inspection functions in inspection component 610 of quality assurance software 600. Entries are made on the main inspection screen 700. The user interface includes a menu bar 750 to create new records or edit existing records. The inspector selects the building 700, floor 710, and location 720 using drop-down list boxes. The inspector then enters values for the applicable inspection functions 740.

In addition to entering values for inspection functions, the inspector also identifies deficiencies for the location, such as lights not working, leaking faucets or soiled carpets. The inspector first selects the category of the deficiency, such as electrical, custodial, plumbing, or carpentry. The quality assurance software then displays the subcategories for the selected category. Table II lists exemplary categories and subcategories for quality assurance system 310.

TABLE II

| Category | Subcategories |
|---|---|
| Building Automation | General |
| Carpentry | Ceiling, Chair, Desk, Door, Drapery Rod, File Cabinet, Floor, |
| | General, Hang Item, Keys, Lock, Name Plate, Shelves, Unlock |
| Custodial | Broken Window, Carpet, Cleanup, Corner Detailing, Drapery, |
| | Dumpster, Dust, Errand, Fixture, Furniture, General, Glass, Hard |
| | Floor, Restroom, Resupply, Spot Clean/Wipe, Trash, Water |
| Electrical | Banner, Clock, General, Light, Mechanical Equipment, Power, Special |
| | Events |
| Elevator Maintenance | General |
| Engineering | Boiler, Building Repair, Chiller, CLG Tower, Compressor, Converter, |
| | Dry Riser, Fan, Filter, Fountain, Gas Booster, General, Generator, |
| | Heater, Lighting, Mechanical, MOD. BLDG. Control, Package Unit, |
| | Press. Reducer, Pump, Screen, Sewage Ejector, Swing Door, |
| | Ventilation, Window |
| Painting | General, Paint, Patch, Refinish |
| Plumbing | Drain, Drinking Fountain, Faucet, General, Sink, Toilet, Urinal |
| Security | Door Service, Escort, Flags, General, Incident Report, Inspect Fire |
| | Exits, Inspect Fire Extinguishers, Medical Emergency, Panic Alarm |
| Tenant Services | Broken Window, Carpet, Drapery, Furniture, General, Keys, Pest |
| | Control |

Once the subcategory is selected, the quality assurance software presents the list of common deficiencies associated with the subcategory. If the selected category is Electrical, and the subcategory is light, the common deficiencies can include “light out”, “light flickering”, etc. The list of common deficiencies for the plumbing category and sink sub-category includes a leaking faucet, a stopped drain, or the absence of hot water. The list of deficiencies is customizable for each installation. The inspector can also enter a text description of the deficiency.

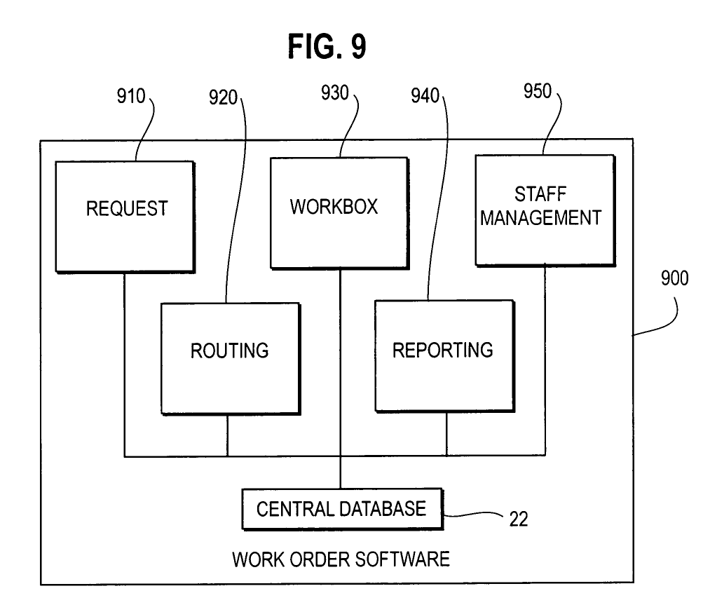

FIG. 8 is an exemplary screen shot of a user interface for entering deficiencies in inspection component 610. Each deficiency for a location is entered on the deficiency screen 800. The inspector selects the location 810 using a drop-down list box. The inspector then selects a priority 820 for the deficiency, a category 830, sub-category 840, and the specific deficiency 850 using drop-down list boxes. The inspector can enter a textual description in text description 860. Deficiency list 870 contains a list of all deficiencies recorded for the location.

The inspector can also take a digital picture of the location or part of the location to illustrate using digital camera 12. An inspector may take a picture of a soiled carpet or overflowing waste bins for a location to document the concern.

When the inspector has completed inspecting one or more locations, the inspector uses the synchronization functionality of the quality assurance software 600 to electronically transmit inspection records to central computer system 20 and database 22. Once inspection records are transmitted to central computer system 20, inspection records are available for aggregation for reporting and comparison purposes, or for transmission to other facility management applications for further processing.

Facility management uses the reporting component 640 to track the performance of the facility. Since each location in a facility is evaluated using the same inspection functions having the same possible values, the cleanliness of the different parts of a facility are readily compared, and cleanliness can be tracked over time. If a particular location, floor or building repeatedly receives lower inspection function values for a particular function, management can track and identify the problem. Cleaning work in one building is analyzed and then compared to cleaning work done in another building.

The staff management component 650 of quality assurance system 100 allows facility management to associate a person with specific facility management roles, such as cleaning, plumbing or electrical maintenance. Each person is also associated in database 22 with the locations for which he or she is responsible, such as all restrooms for the building 30 or all conference rooms on the first two floors. Multiple people can be associated with a particular location, such as where different people are responsible for cleaning a room on different shifts. The values of the inspection functions for the locations to which the person is assigned gives the building management a method to track the performance of the employees responsible for the cleaning or maintenance work. Above or below average inspection values for the locations for which a staff member is responsible can be used for rewards or disciplinary action, respectively, at the discretion of facility management. The results might suggest a need for further training, for example, or a need to change practices by having floors cleaned more frequently. A building supervisor can look at the values for an employee over the last 12 months and use them to document plans for a bonus or disciplinary action or to help with an annual review.

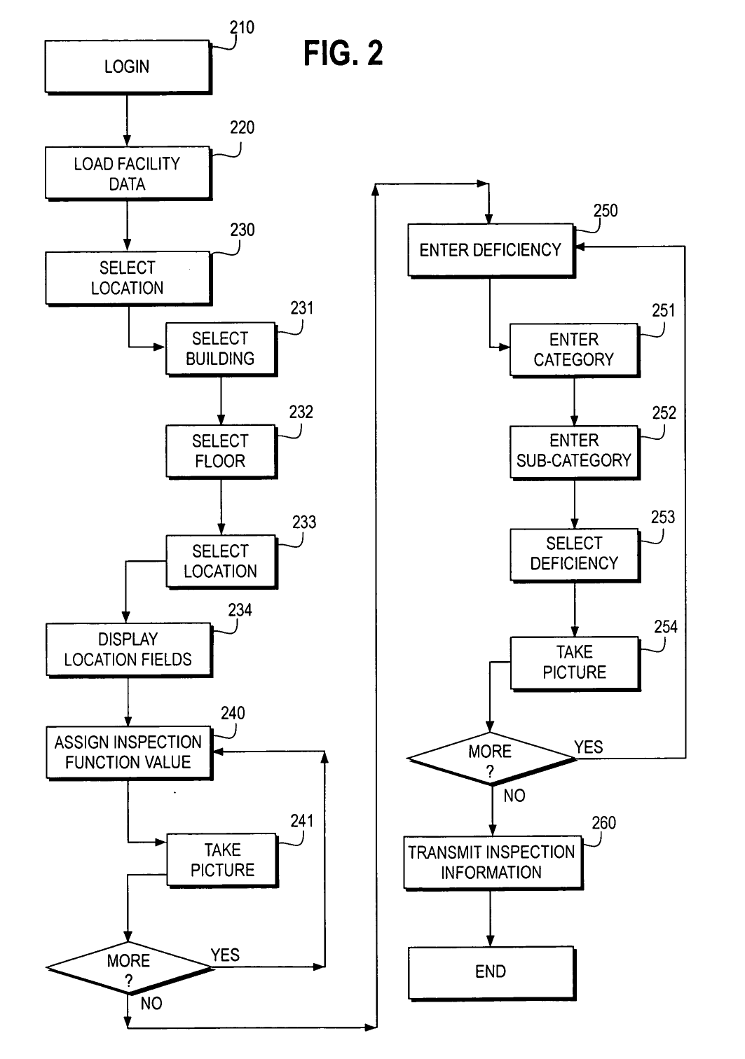

FIG. 2 is a flow chart illustrating a preferred operation of the quality assurance system 100 for inspecting a managed facility. The inspector logs into inspection device 10 (210). The local database 635 on inspection device 10 is loaded with facility data about the facility or subset of the facility to be inspected from database 22 (220). The loaded facility data may be limited to data for locations and categories with which the inspector is associated in central database 22. Once facility data for the building to be inspected is loaded into inspection device 10, the inspector begins the inspection process. The inspector selects the location to be inspected from the list of available locations (230). In order to keep the list of locations from being too long, it is reduced by first prompting the inspector to select the appropriate building and floor from the list of available buildings (231) and floors (232) respectively. After the floor is selected, the inspector is prompted to select the location from the list of locations available on that floor (233). After the location is selected, the inspection information fields applicable to the location type are displayed (234), including the inspection functions and deficiencies. At this point, the inspector inspects the location and assigns values for each of the applicable inspection functions (240). The inspector repeats step 240 until all of the inspection functions applicable to the location type have been entered and recorded in memory card 11. Using digital camera 12, the inspector may justify a specific inspection function value by taking a digital picture illustrating the reason for the value and recording the digital picture on memory card 11 (241).

Once values are assigned for the applicable inspection functions for a location, the inspector then records specific deficiencies for the location (250). As discussed above, each location type can have a specific list of deficiencies. In the embodiment of the invention described in FIG. 2, deficiencies are further grouped by category (such as electrical, plumbing or cleaning) and sub-category. When the inspector recognizes a defect, the inspector selects the category of that defect from the list of available categories (251). Once the category is selected, the inspector selects the deficiency sub-category from the list of available sub-categories (252). Once the sub-category is selected, the inspector selects the deficiency from the list of available deficiencies. The inspector may add individual comments in a description field (253), and take a digital picture of the deficiency for documentation (254). The deficiency and supporting information is recorded in memory card 11 (255). The inspector repeats step 250 until all of the defects associated with a location are identified and recorded. If necessary, the inspector can review the list of entered deficiencies for a selected location and change the recorded values (256).

After the inspector has finished inspecting one or more locations, the inspection device 10 transmits the inspection information for the locations to central computer system 20 (260). The inspector can perform this step after inspecting a single location, or inspecting multiple locations for a facility, depending on the connection availability to central computer system 20 and personal preference.

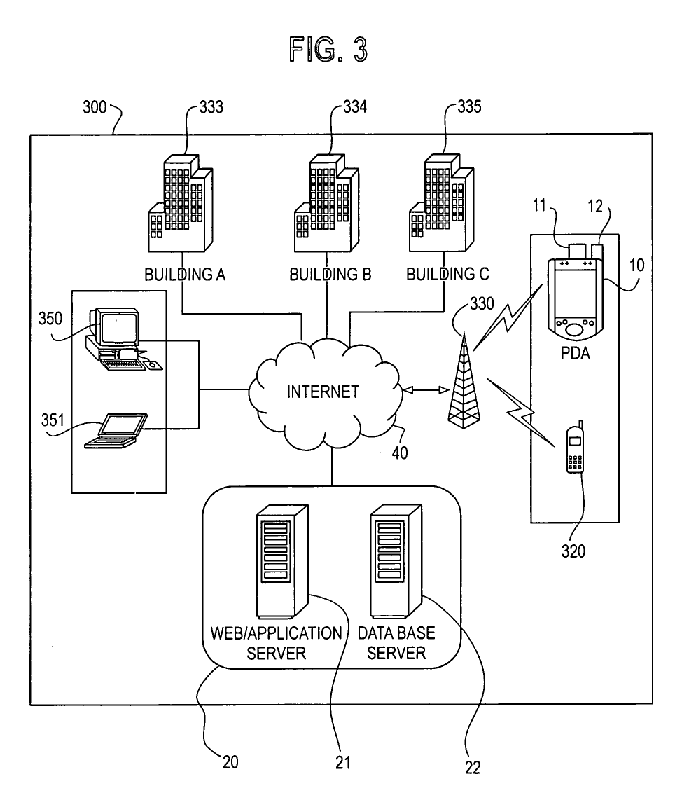

FIG. 3 shows an embodiment of a facility management system 300 having a quality assurance system 305 (not shown) further integrated with a work order system 310 (not shown). Quality assurance system 305 includes the functionality of quality assurance system 100 of FIG. 1 with additional functionality for communicating information to work order system 310. The work order system 310 receives and monitors requests to repair conditions and defects identified by an inspection. These requests are known as work orders. Requests for work orders can either be generated by quality assurance system 305 and transmitted to work order system 310, as described below, or manually entered into work order system 310. In the embodiment shown in FIG. 3, the work order request represents a repair or other task to be performed for a managed facility.

Work order system 310 includes work order software executing on application server 21 accessible over Internet 40 via a web browser. Work order system 310 shares central database 22 with quality assurance system 305. Maintenance supervisors can access work order software using a supervisor computer 350. Maintenance workers access work order software using digital maintenance devices 320. Maintenance device 320 is preferably a web-enabled mobile phone that executes a web browser and accesses the work order software through wireless communications 330 and Internet 40. Maintenance device 320 preferably uses the Wireless Application Protocol (WAP) standard for wireless communication. Alternative embodiments of maintenance device 320 receive text message communications over wireless communications 330, such as Short Message System (SMS) messages. Wireless communications 330 include cellular telecommunications for maintenance device 320. Inspection device 10 communicates with central computer system 20 and Wi-Fi wireless access point 32 (not shown) for inspection device 10.

FIG. 9 illustrates software components utilized in one embodiment of work order software 900. Work order software 900 includes a request component 910 for manually entering work order requests, a routing component 920 to distribute work order requests, work orders and other work order-related communications to the appropriate personnel, and a workbox component 930 providing each person the ability to view and respond to work order-related communications. Work order software 900 also includes a staff management component 950 to track appropriate personnel, and a reporting component 940 to produce performance reports.

The work order software 900 uses the same list of inspection targets, categories and subcategories as the quality assurance software in database 22 in order to avoid inspectors and maintenance personnel using different words to describe the same problem. Using the same data also allows for automatic communications between the quality assurance software and the work order software.

Work order requests and work orders are communicated by work order system 310 using work order records. Preferably, work order requests use the same work order record format as work orders with a different status. Work order system 310 allows three different types of work orders. Instant work orders are created for immediate maintenance problems, and are transmitted directly to the maintenance personnel for remediation. Scheduled work orders are one-time events, but are entered in advance. Scheduled work orders contain a date and time that the work order should be performed. Periodic work orders are used for recurring maintenance events performed according to a regular schedule. Periodic work orders contain additional information regarding the period and frequency of the maintenance to be performed. Table III lists certain fields in an instant work order record.

TABLE III

| Field | Description |
|---|---|
| Status | Each work order can be in one of the following |
| | states: Initial, New, Assigned, Accepted, |
| | Declined, Rerouted, Timed out, Hold, |
| | Completed, Canceled, In progress, or |
| | Scheduled |
| Priority | Each work order is assigned one of the |
| | following priorities: High, Medium, Low, or |
| | Preventative Maintenance (PM) |
| Category | The category of the work order. |
| Subcategory. | The subcategory of the work order. |
| Target identification | The identity of the target to be repaired |
| Name of person | The person assigned to remedy the work order |
| | (if any). |
| Contact name | The person that requested the repair (if any) |
| Problem. | The Problem field is used to describe what |
| | went wrong to create the need for the work |
| | order. |
| Solution | The Solution describes what the maintenance |
| | person did to correct it. |

Alternative embodiments also provide additional fields such as the date and time the work order request was created and the date and time the work order was marked as completed.

Work order requests are either received electronically from the quality assurance system, or are generated manually using the request component 910. The inspection component 610 of the quality assurance software 600 contains functionality for generating work order requests. When an inspector identifies a deficiency, the inspector can generate a work order request to have the deficiency repaired. The inspector assigns a priority to the work order request and can also enter a text description. The work order request contains the target to be repaired and the specific problem to be remedied, including the category and subcategory. In an alternative embodiment, quality assurance software automatically generates a work order request based on the value entered for one or more inspection functions for a target. When quality assurance software transmits inspection records to central computer system 20, central computer system 20 transmits any work order requests to the routing component of the work order software.

The request component 910 executes as a web application on application server 21 and allows the user to select the relevant information for the work order request using drop-down lists to avoid data entry errors. The relevant information identifies the target to be repaired, the contact name of person requesting the repair and the priority for the request. Relevant information also includes the category and subcategory of the problem. The request component 910 also allows the user to enter a textual description of the problem and attach files such as word documents or pictures of the target to be repaired. An attachment can include warranty or vendor information or part of an instruction manual. The contents of the drop-down lists are retrieved from database 22. The request component 910 includes a request log for viewing open requests. The request component 910 also provides functionality for editing and canceling existing requests, as well as resubmitting requests to the routing component for additional routing, as described below.

The routing component 920 controls message traffic between the various personnel using the work order system. The routing component 920 routes work order related communications, including work order requests and work orders, to the appropriate maintenance personnel for review and further processing. The routing component 920 includes rules for determining the appropriate maintenance personnel to receive the communication at each stage of the work order process. The rules are customizable based on the application. The routing component 920 interfaces with the staff management component 950 to retrieve personnel function, such as category, and availability information such as shift, vacation and attendance. For example, the routing component 920 contains rules to route a work order request to the currently available supervisor having responsibility for the category and/or subcategory of the request. In the event no supervisor is available for the category, the routing component 920 includes rules to route the work order request to another available supervisor. The routing component 920 also monitors routed work order requests to determine whether the maintenance person to whom the request has been routed has responded or acknowledged receiving the communication. In the event the person has not responded within a configurable amount of time, the routing component 920 includes rules for rerouting the communication until someone has acknowledged receiving the communication. The routing component 920 also includes reminder functionality for sending periodic reminders to maintenance personnel until a work order has been completed, and alert functionality for sending immediate communications to a user's device. Alert functionality can send a text alert to a user using a maintenance device 320 indicating that a new work order communication has been sent to the user and the user should check the user's workbox for more detail. Alternative embodiments also send alerts via cell phones, pagers or e-mail. After a worker accepts a work order the system periodically sends an alert to the worker to ask if the project is finished, on hold, or cancelled. The period for the alert is scheduled in the system, such as a certain number of hours after the worker accepts the work order, or at the end of the worker's shift.

The workbox component 930 provides a user interface for personnel to review and interact with work orders and work order requests. Each person has a workbox for viewing work orders and work order requests for which the person is currently responsible. The workbox component 930 provides functionality for viewing more detail regarding a work order communication. The workbox component 930 also provides different types of users with different functionality, such as supervisors and workers. Supervisor workboxes include approval functionality for approving or rejecting work order requests. Approved work order requests become work orders. Approval functionality also includes comments. For rejected work orders, the supervisor can include text comments describing the reason for rejection. Supervisor workboxes include assignment functionality to assign work orders to the appropriate available worker. The assignment functionality provides a list of the recommended personnel, based on the personnel function and availability. Additional criteria include the number of work orders that are currently assigned to the worker. The assignment functionality preferably includes customizable rules, such as creating a rotation among multiple workers. Supervisor workbox functionality preferably includes the ability to access worker workboxes and view and edit work orders. Supervisor workbox functionality also preferably includes the ability to view previously assigned work orders and reassign to other workers.

Worker workboxes preferably include functionality to accept or decline assigned work orders, and to enter a reason for declining a work order. The worker workbox also allows the maintenance worker to provide more detailed information about the repair by displaying drop down lists of common problems and solutions for each problem stored in database 22, or to enter text comments regarding the problem or solution. Worker workboxes include functionality to mark a work order as completed. Worker workboxes also preferably include functionality to place an accepted work order on hold for a certain number of days. Accepted work orders remain displayed in an employee's workbox until they are completed. When a work order is completed it will remain in the system database for tracking and reporting purposes but will no longer appear in any online inbox.

The worker who is assigned a work order remains responsible for it unless it is reassigned to someone else. If the worker reaches the end of his or her shift the record will remain there until the worker returns to work. However, if the project needs to be completed sooner than that, the worker can cancel the work order, and select “End of Shift” as the reason. The routing component automatically forwards the work order to the workbox for the supervisor of the next shift. The supervisor can then assign the work order to someone else.

The staff management component 950 and reporting component 940 of work order system 310 offer similar functionality as discussed above with respect to quality assurance system 100. For each maintenance person, the staff management component 950 records the person's role (e.g., supervisor or worker) and the category and/or subcategories for which the person is responsible. The staff management component 950 also contains availability information, such as the shift to which the person is assigned and tracks vacation. The staff management component 950 also tracks attendance each day to determine the available personnel. The staff management component 950 provides functionality to enter attendance records, shift changes, vacation plans, and other personal information about the personnel in the staff management component 950. The staff management component 950 also provides functionality to add new employee records and edit and remove old ones. The work order system 310 will use this information when presenting a list of available staff members to a supervisor when the supervisor needs to assign a work order. The staff management component 950 also can be used to track the performance of maintenance personnel in a fashion similar to quality assurance system 100 described above. Because personnel can be associated with specific targets, inspection results for those targets can be used to track the performance of maintenance workers. For example, where a maintenance worker has marked a work order for a target as completed and a subsequent inspection reveals the defect was not fixed, the worker's performance can be tracked. Also, the reporting component 940 can produce reports regarding the number of work orders a person has completed, the average amount of time to complete, and the number of satisfactory completions. This information can be used to compare the worker against other workers having a similar role.

Referring again to FIG. 3, work order system 310 is shown in the context of inspecting commercial property facilities. Work order system 310 shows a facility having multiple buildings to be managed, building A 333, building B 334, and building C 335. The work order system uses the same facility information, such as the list of locations, and defect category and subcategory information stored in database 22 for the quality assurance program 305. This ensures that inspectors and maintenance personnel use consistent terms for describing defects. Work order requests are received from facility inspectors for deficiencies for a location using quality assurance system 305 to identify problems such as cleaning, electrical or plumbing. Work order requests may also be entered by building tenants and facility management personnel using the request component of the work order software. The categories and subcategories used by work order system 310 to identify work order requests and work orders are stated in Table II above. Alternative embodiments provide for the quality assurance system to automatically generate work orders based on the inspection function values for a location. For example, an unacceptable value for the carpeting for a conference room automatically generates a work order request for the carpet to be cleaned. Work order requests are also manually entered through the request component 910 of the work order software 900 by tenants using tenant computer 351, or by workers at a facility call center (not shown) taking phone calls from tenants.

Work order requests must be approved by maintenance supervisors or other building management before a worker is assigned to the repair. When a work order request is received, the routing component 920 of the work order software 900 routes the work order request to the workbox of the appropriate supervisor. The routing component 920 processes its rules to automatically select a supervisor based on the location of the problem, the category of the problem, and availability of the supervisors. If the problem is a light out in a location in Building A 333, the routing component 920 sends the work order request to the workbox of the supervisor responsible for electricity for Building A 333 for the current shift. If Building A 333 has multiple supervisors for electricity for a shift, such as where supervisors are assigned to certain floors, the routing component 920 processes the list of available supervisors according to its rules to determine the appropriate supervisor to receive the request. The routing component 920 preferably routes the request to an available supervisor assigned to the particular location. Alternative embodiments include other rules, such as a rotation for routing requests. The routing component 920 also sends an alert to the selected supervisor that a request has been sent. The maintenance supervisor reviews the outstanding work order request through a supervisor workbox. The supervisor must approve or reject the request. If the supervisor fails to either accept or reject the work order within a certain time, the routing component removes the request from the supervisor's workbox and routes the request to the next available supervisor. If no supervisor for electricity is available, the routing component 920 may escalate the request to building management for attention.

If the request is approved, the request becomes a work order. The supervisor then assigns the work order to the appropriate worker to complete. The work order software 900 automatically suggests a list of workers based on the location, the category of the problem, and the availability of the workers. The work order software 900 excludes absent workers from the list to ensure that the work order is completed. In the case of a light out, the work order software suggests a list of available electricians. Once the supervisor selects an electrician, the work order is routed to the electrician, and the routing component 920 sends an alert to the electrician regarding the work order.

The electrician views the work order through a worker workbox, and must accept or decline the work order within a specified amount of time. If the worker declines the work order, he or she must also select a reason for declining from a list of common reasons stored in database 22, and then the work order returns to the supervisor's inbox. If the electrician does not accept or decline the work order after a specified period of time, the work order management system automatically returns the work order to the supervisor's workbox for reassignment and alerts the supervisor. This acceptance requirement ensures that work orders are not lost if the electrician is not available or the maintenance device 320 is not operable.

When the worker performs the repair, the worker enters more information regarding the deficiency in the workbox. For example, in the case of a light out, the electrician will identify the root cause of the problem, such as a burned out light bulb, an overloaded circuit breaker, or a problem with the light fixture itself. In the case of an inoperable bulb, the worker would select “burnt-out bulb” from the list of common problems, and would select “replace bulb” from the list of common solutions associated with the “burnt-out bulb” problem.

The electrician can also place the work order on hold, such as where the facility does not have any replacement bulbs in inventory. The work order software pages the worker on the date that the worker selected to finish the project. When the maintenance worker has completed the repair, the maintenance worker marks the work order as completed.

Although the work order requests described above are transmitted to a supervisor as soon as they are received, also known as instant work order requests, the work order system also allows facility management to schedule one-time or recurring work order requests. Scheduled work orders are one-time events, but are delivered to the appropriate supervisor on the date and time that the work order should be received. Scheduled work order requests are created by a building manager, chief engineer or supervisor. An example of a scheduled work order request is a work order request created in response to a tenant request for a project to be done at a later date, such as fixing a leaky faucet after normal business hours. Periodic work order requests are recurring tasks scheduled to happen regularly, such as every Monday morning, or once a month on Friday night.

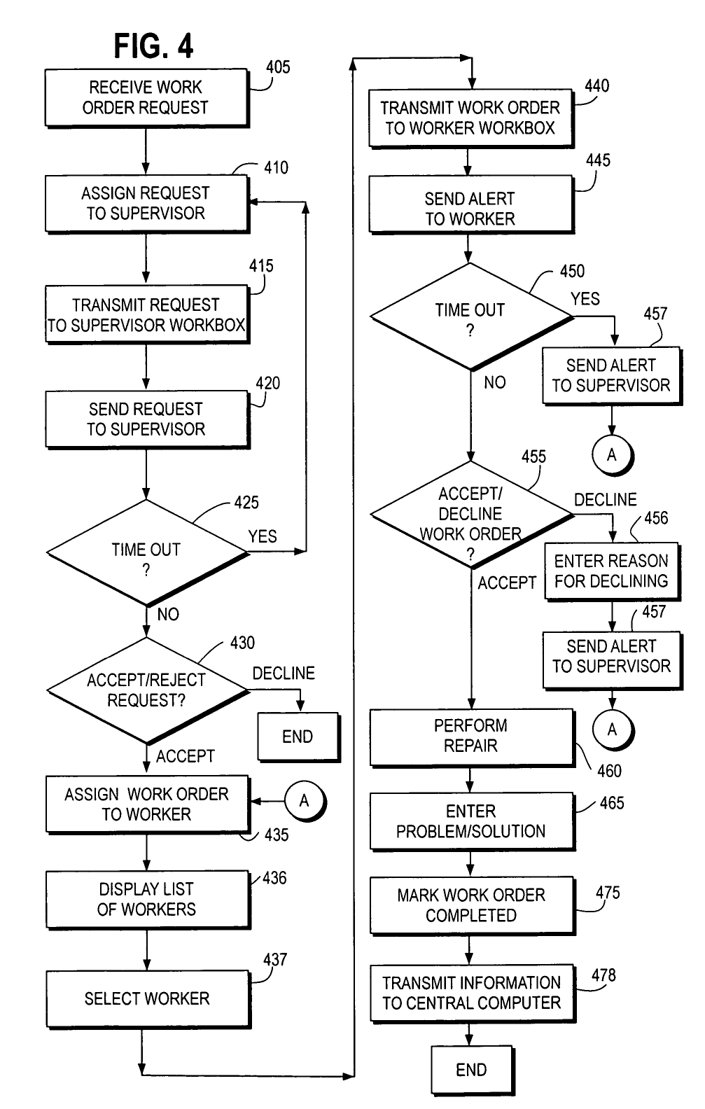

FIG. 4 is a flow chart illustrating one operation of work order system 310. The work order system 310 receives a work order request, step 405. Work order requests may be created by quality assurance system 300 or manually entered into the request component 910 as described above. The work order system 310 assigns the work order request to the appropriate supervisor for the category of the request, step 410. The work order request is transmitted to the supervisor's inbox for approval and assignment, step 415, and an alert is sent to the supervisor, step 420, such as by a text message to the supervisor's message-enabled phone. In order to ensure that the work order request is processed, the system monitors the work order request to ensure that the supervisor has acknowledged receiving the request within the specified timeout period, step 425. If the supervisor has not acknowledged the receipt of the request within a specified timeout period, the work order system assigns the work order request to the next available supervisor, repeating step 410.

The supervisor may approve or reject the request, step 430. Once the supervisor approves the work order request, the work order request becomes a work order. If the supervisor rejects the work order request, the request is removed from the supervisor's inbox and the process ends for that request. If the supervisor accepts the work order request, the request becomes a work order. The supervisor assigns the work order to an appropriate worker to be completed, step 435. The work order system displays the list of workers available for the work order category, step 436, based on the work order category, location and the staff availability. Once the supervisor selects the appropriate worker, step 437, the work order is transmitted to the workers inbox, step 440, and an alert is sent to the worker's maintenance device, step 445. Each worker views the inbox on maintenance device. In order to ensure that the work order is processed, the system monitors the work order to ensure that the worker has acknowledged receiving the work order within the specified timeout period, step 450. If the worker has not responded within the specified timeout period, the system sends an alert to the supervisor, step 451, and the supervisor assigns the work order to the next available worker, step 435. The worker must accept or decline the work order, step 455. If the worker declines the work order, the worker must enter the reason for declining, step 456, e.g., the worker is already working on another work order. Common reasons for declining may be selected from a drop-down list. Once the worker has entered a reason for declining, the system sends an alert to the supervisor, step 457, and the supervisor must assign the request to the next available worker, step 435. Once the worker accepts the work order, the worker performs the requested repair, step 460. After the repair is completed, the worker enters the problem that necessitated the repair and the solution the worker performed to repair the problem, step 465. These common problems and solutions may be selected from drop-down lists, or if additional information is needed, a textual description may be entered. Once the problem and solution are entered, the work order is marked as completed, step 470, and the work order information is transmitted to central computer system 475.

In alternative embodiments of the present invention, additional facilities management applications are integrated with the quality assurance and work order systems. These additional applications operate on central computer system 20, store information in database 22 and share business objects and common database tables with the quality assurance and work order systems. Additional applications share common facility and location information with the quality assurance system and work order system in database 22 as described above, such as the list of locations and categories.

One alternative embodiment includes an integrated events planning component. The events planning component includes a notification utility for communicating facility events to the appropriate personnel. The events planning component notifies appropriate tenants and personnel of planned maintenance, such as an effort to replace carpeting. A building manager enters a planned event into the event planning component, which stores the event in database 22. For each event, the building manager designates the categories of staff and tenants who need to be notified, such as security, housekeeping, and electrical. Housekeeping may need to set up extra tables or chairs for a meeting, or the security staff might want to have extra employees on hand. Because the events planning application shares facility and location information with the quality assurance and work order applications, scheduling conflicts are avoided. For example, if a press conference is scheduled for a conference room location on a certain date, the housekeeping staff will need to thoroughly clean the location prior to the event, and the maintenance staff will need to complete any urgent repairs for the location prior to the event and postpone any routine maintenance scheduled during the event, such as inspecting heating and air conditioning equipment. The events planning component also includes a calendar of upcoming events for tenants and facility personnel to review.

Another alternative embodiment includes an integrated automation equipment component. The automation equipment component monitors data provided by any type of automated equipment, including lighting and security systems, elevators, and heating, ventilation, and air conditioning systems. Most modern elevator or heating systems have computer processors built in to monitor their performance and to send messages or alerts to support staff if problems appear. These emergency or monitoring messages are received by central computer system 21 and used to generate work order requests. For example, if the automation equipment module received a message from an air conditioning unit that is overheating or from an elevator that is due for routine maintenance, the module would automatically generate a work order and send it to the appropriate supervisor.

Another alternative embodiment includes an integrated security component for alerting security guards to security-related events. A user could access a security application and enter a request for a delivery or an appointment at a specific time. The system would send a message to the security supervisor, and after the supervisor approves the request, he or she would send a broadcast message to every member of the security staff in the facility. All of the security employees in the building, wherever they are, would at once receive a notice of the delivery or visit on their cell phones or PDAs. If a tenant must change or cancel a delivery or appointment, or if a new delivery or visit must be added at the last moment, the entire security staff would learn immediately about these changes. This means that any security employee can accept a delivery. After an employee accepts a delivery, the delivery record disappears from the list of pending deliveries for every employee with access to the system. If a security guard sees a stranger on the premises, that guard could ask the visitor to identify himself, and then check to see if the Security system includes a record for this person. Printed lists for appointments or deliveries become unnecessary, and security guards are free to roam around the facility they are paid to protect.

An alternative embodiment of the invention further integrates a billing component into the system. The billing component operates on central computer system, 20. In this embodiment of the invention, database 22 further stores tenant information for each facility. In the present invention, a tenant is any entity that occupies a space. Thus a tenant could be a department within a corporation that owns a building or an actual tenant that holds a lease and pays rent to the property owner. The billing component allows facility management personnel to track income and expenses for the property or properties being managed. The billing component tracks the costs involved in providing cleaning and maintenance services for each tenant so that the facility management personnel can bill the tenant for these services, and then manage receipts and overdue payments. For example, if an electrician replaces a thermostat for a particular tenant, the system will allow the building management to track this expense and bill the tenant for it. The billing component also allows facility management personnel to track costs for providing these services internally, in terms of work hours and costs per employee per hour, and expenses for supplies and equipment. Finally, the billing component also stores information about vendors in database 22, and allows facility management personnel to track payments to each vendor for services related to building maintenance and management. For example, the billing component allows facility management personnel to generate invoices for cleaning supplies and track payments made to vendors for these supplies.

Another alternative embodiment integrates an inventory component operating on central computer system 20. The inventory component allows the client to track cleaning and maintenance supplies and equipment for any facility. The system stores the current amount of a type of supply in database 22. For example, the inventory component tracks the number of gallons of floor wax in stock for a particular facility. After completing a cleaning project, the cleaning staff records the number of gallons of floor wax used. The inventory component transmits an alert to a supervisor if the amount of floor wax in stock falls below a certain number of gallons, and automatically creates a purchase order for a specified minimum number of gallons. In one embodiment, the purchase order is automatically sent directly to the vendor, such as by electronic mail, while in other embodiments the system requires a supervisor's approval before transmitting the purchase order. Invoices and other information can be sent by fax, email, or web services, depending on the vendor. The inventory component also tracks invoices received from vendors. If the invoice is received electronically, invoice information is stored in database 22 automatically. The inventory component also tracks payments on invoices and delivery of products. The inventory component also automatically prints checks for payment, and allows employees to update the inventory when shipments are received. The inventory component includes other functions, including allowing employees to record when a vendor sends a damaged or incorrect product, or an incorrect amount of product. The inventory component can automatically send a response to the vendor, and withhold or change a payment according. The inventory component also includes a reporting utility that will track what is delivered. Another embodiment of the inventory component is integrated with a digital signature system to authenticate purchase orders, invoices, and other inventory-related correspondence.

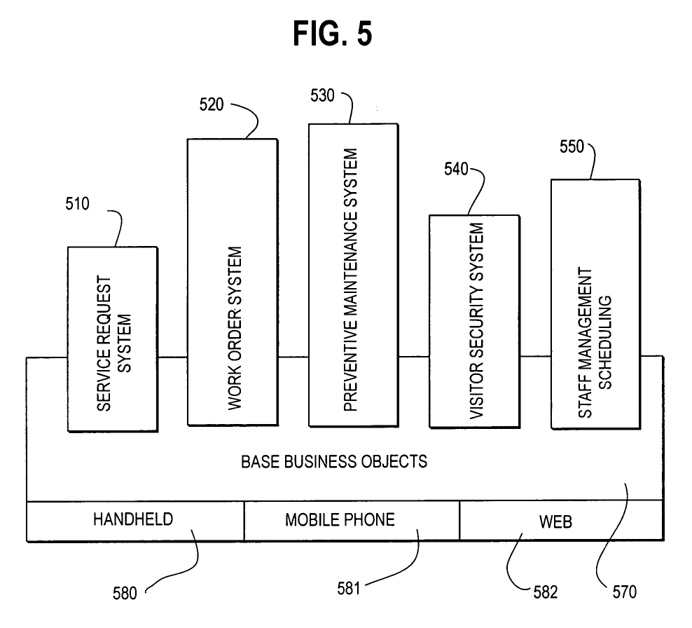

FIG. 5 illustrates a facility management system 500 for performing and tracking tasks other than normal building maintenance tasks. Facility management system 500 operates on a central computer system 20 as shown in FIGS. 1 and 3, and access database 22. The multiplatform layer 570 allows each system to interface with any device, such as cell phones 580, web browsers 581, and handheld PDAs 582. The multiplatform layer 570 includes common business objects shared by each software application. Common business objects include information and methods applicable to any facility, including building information, tenant information, staff information, and categories and subcategories for work orders. Facility management system 500 includes a work order system 520 similar to work order system 310 of FIG. 3. Service request system 510 is separate from work order system, allowing tasks other than maintenance to be requested. Preventative maintenance system 530 is also separate from work order system 520 for scheduling recurring tasks. Preventative maintenance system includes a user interface for entering, editing and deleting preventative tasks, as well as data stored in database 22 regarding preventative maintenance tasks. Information about targets to be serviced, such as warranty information, is stored in database 22. Copies of documentation can also be attached and stored in database 22. Preventative maintenance tasks can be any recurring event and are not limited to traditional building maintenance or engineering tasks. Preventative maintenance system 530 interfaces with work order system 520 to create a work order whenever a scheduled task must be performed, and the routing component of work order system 520 routes the task to the appropriate supervisor or worker based on the category of the task. Facility management system 500 also includes an integrated security system 540 as discussed above and a staff management component for scheduling and accessing staff across all of the systems of facility management system 500.

Because the staff management component and base business objects are shared across multiple applications, work orders can be created for any building management task, not just maintenance or engineering. For example, a preventative maintenance task can be created for security to inspect fire exits in a building every day. The task is assigned a category of security and a subcategory of “Inspect Fire Exits” when it is entered. Each morning the preventative maintenance system sends a work order to the work order system 520. The routing component of the work order system 520 automatically assigns the work order to one of the available security workers for the building based on the security category and availability information in staff management component 560. The security worker receives the task in a workbox on a WAP-enabled mobile phone, and the work order is processed as described above with respect to work order system 310.

The foregoing disclosure of embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosures. The scope of the invention is to be defined only by the claims appended hereto, and by their equivalents.

1. A system for inspecting a facility having a plurality of locations, comprising:
a central computer system having a central database and a microprocessor;
said central database having records for said plurality of locations and a plurality of inspection functions;
an inspection device having a local database and a microprocessor,
said local database having records for said plurality of locations and said plurality of inspection functions;
said microprocessor programmed to execute quality assurance software, said quality assurance software including computer readable instructions for performing the method of:
entering inspection information for a location from said plurality of locations, wherein said inspection information includes values for one or more inspection functions from said plurality of inspection functions;
storing said inspection information in said local database; and
transmitting said inspection information to said central computer system; and
said microprocessor of said central computer system programmed to execute server software, said server software including computer readable instructions for performing the method of:
receiving said inspection information for said location from said inspection device;
storing said inspection information in said central database; and
calculating an overall location score for said location based on the weighted average of said values of said inspection functions in said inspection information for said location.

2. The system as claimed in claim 1, wherein the server software further includes computer readable instructions for performing the method of:
calculating an overall score for said facility based on the weighted average of the overall location score for each location in said facility.

3. The system as claimed in claim 1, wherein the inspection device further includes a digital camera;
said quality assurance software further including computer readable instructions for performing the step of taking at least one digital picture of said location using said digital camera, and wherein said inspection information further includes said digital picture.

4. The system as claimed in claim 1, wherein said server software further includes a staff management component having computer readable instructions for performing the method of:
entering worker information for each worker in a plurality of workers, said worker information including at least one location associated with said worker;
storing said worker information in said central database.

5. The system as claimed in claim 1, wherein said server software further includes a reporting component having computer readable instructions for performing the method of:
selecting at least one location from said plurality of locations;
for each location, reading said inspection information from said central database; and
producing a report based on said inspection information.

6. The system as claimed in claim 4, wherein said server software further includes a reporting component having computer readable instructions for performing the method of:
selecting at least one worker from said plurality of workers;
for each location associated with said worker, reading said inspection information for said location from said central database; and
producing a report based on said worker, said locations, and said inspection information.

7. The system as claimed in claim 1, wherein said central database further includes records for a plurality of categories and records for a plurality of deficiencies, each deficiency in said plurality of deficiencies associated with one category from said plurality of categories;
said central database includes records for a plurality of maintenance workers, each maintenance worker in said plurality of maintenance workers associated with at least one location from said plurality of locations and at least one category from said plurality of categories; and
said local database further includes records for said plurality of categories each deficiency in said plurality of deficiencies associated with one category from said plurality of categories.

8. The system as claimed in claim 7, wherein said quality assurance software further includes computer readable instructions for performing the method of:
generating a work order for at least one location from said plurality of locations based on one of said deficiencies for said location;
associating said work order with said category associated with said deficiency; and
transmitting said work order to said central computer system;
said server software further includes work order software having computer readable instructions for performing the method of:
receiving said work order from said quality assurance software;
automatically selecting one maintenance worker from said plurality of maintenance workers based on said location and said category associated with said work order; and
routing said work order to said maintenance worker.

9. The system as claimed in claim 8, wherein said server software work order software further includes computer readable instructions for performing the method of:
verifying whether said maintenance worker accepted said work order;
if said maintenance worker did not accept said work order, automatically selecting a second maintenance worker from said plurality of maintenance workers based on said location and said category associated with said work order.

10. The system as claimed in claim 8, wherein said server software further includes a staff management component having computer readable instructions for performing the method of entering availability information for each maintenance worker in said plurality of maintenance workers and storing said availability information in said central database; and
said computer readable instructions of said work order software for performing the step of automatically selecting one maintenance worker further include automatically selecting said maintenance worker based on said availability information for said plurality of maintenance workers.

11. The system as claimed in claim 7, wherein said central database further includes records for a plurality of maintenance supervisors, each maintenance supervisor in said plurality of maintenance supervisors associated with at least one location from said plurality of locations and at least one category from said plurality of categories;
said quality assurance software further includes computer readable instructions for performing the method of:
generating a work order request for at least one location from said plurality of locations based on one of said deficiencies for said location;
associating said work order request with said category associated with said deficiency; and
transmitting said work order request to said central computer system;
said server software further includes work order software having computer readable instructions for performing the method of:
receiving said work order request from said quality assurance software;
automatically selecting one maintenance supervisor from said plurality of maintenance workers based on said location and said category associated with said work order request;
routing said work order request to said supervisor;
said work order software further including a workbox component having computer readable instructions for performing the method of:
displaying said work order request to said supervisor;
generating a work order based on said work order request;
automatically selecting one maintenance worker from said plurality of maintenance workers based on said location and said category associated with said work order; and
routing said work order to said maintenance worker.

12. The system as claimed in claim 11, wherein said server software further includes a staff management component having computer readable instructions for performing the method of entering availability information for each maintenance worker in said plurality of maintenance workers and storing said availability information in said central database; and
said computer readable instructions of said workbox component for performing the step of automatically selecting one maintenance worker further include automatically selecting said maintenance worker based on said availability information for said plurality of maintenance workers.

13. The system as claimed in claim 11, wherein said work order software further includes computer readable instructions for performing the method of:
verifying whether said maintenance worker received said work order;
if said maintenance worker did not receive said work order, automatically selecting a second maintenance worker from said plurality of maintenance workers based on said location and said category associated with said work order.

14. A system for managing work orders for a commercial facility having a plurality of locations, comprising:
a central computer system having a central database and a microprocessor,
said central database having records for said plurality of locations, a plurality of categories and a plurality of deficiencies, each deficiency in said plurality of deficiencies associated with one of said categories,
said central database having records for a plurality of maintenance workers, each maintenance worker in said plurality of maintenance workers associated with at least one location from said plurality of locations and at least one category from said plurality of categories;
said microprocessor programmed to execute work order software, said work order software including a request component having computer readable instructions for performing the method of:
generating a work order request for one location from said plurality of locations; and
associating said work order request with one of said deficiencies for said location;
automatically selecting one maintenance supervisor from said plurality of maintenance workers based on said location and said category associated with said work order request;
routing said work order request to said supervisor;
said work order software further including a workbox component having computer readable instructions for performing the method of:
displaying said work order request to said supervisor;
generating a work order based on said work order request;
automatically selecting one maintenance worker from said plurality of maintenance workers based on said location and said category associated with said work order; and
routing said work order to said maintenance worker.

15. The system as claimed in claim 14, wherein said work order software further includes a staff management component having computer readable instructions for performing the method of entering availability information for each maintenance supervisor in said plurality of maintenance supervisors and storing said availability information in said central database; and
said computer readable instructions of said work order software for performing the step of automatically selecting one maintenance supervisor further include automatically selecting said maintenance supervisor based on said availability information for said plurality of maintenance supervisors.

16. The system as claimed in claim 14, wherein said work order software further includes a staff management component having computer readable instructions for performing the method of entering availability information for each maintenance worker in said plurality of maintenance workers and storing said availability information in said central database; and
said computer readable instructions of said workbox component for performing the step of automatically selecting one maintenance worker further include automatically selecting said maintenance worker based on said availability information for said plurality of maintenance workers.

17. A method for inspecting a managed facility having a plurality of locations using a quality assurance system including an inspection device having a local database and a central computer system having a central database, comprising:
storing records for said plurality of locations, a plurality of inspection functions, and a plurality of deficiencies in said central database;
storing records for said plurality of locations, said plurality of inspection functions, and said plurality of deficiencies in said local database;
executing quality assurance software on said inspection device;
inspecting a location from said plurality of locations using said quality assurance software, said inspection including the steps of:
selecting said location from said plurality of locations stored in said local database;
recording inspection information for said location,
said inspection information including values for one or more inspection functions from said plurality of inspection functions,
said inspection information including one or more deficiencies from said plurality of deficiencies; and
transmitting said inspection information from said inspection device to said central computer system; and
recording said inspection information in said central database.

18. The method as claimed in claim 17 wherein each record for said plurality of inspection functions in said central database further includes a weight, further comprising:
calculating a total value for one location in said plurality of locations based on the values and weights for said inspection functions for said location.

19. The method as claimed in claim 17, further comprising:
storing records for a plurality of maintenance workers in said central database;
storing records for a plurality of categories in said central database;
for each deficiency in said plurality of deficiencies in said central database, associating said deficiency with one category from said plurality of categories;
for each maintenance worker in said plurality of maintenance workers, associating said maintenance worker in said central database with one or more locations from said plurality of locations and one or more categories from said plurality of categories, and storing availability information for said worker in said central database;
executing work order software on said central computer system;
creating a work order for one location in said plurality of locations using said work order software;
associating said work order with one of said deficiencies for said location;
automatically selecting one maintenance worker from said plurality of maintenance workers using said work order software,
said selection based on the location and category associated with said deficiency and the location and category associated with said maintenance worker; and
routing said work order to said maintenance worker using said work order software.

20. A method for electronically managing work orders for a facility having a plurality of locations using a work order system including a central computer system having a database, comprising:
storing records for said plurality of locations, a plurality of categories and a plurality of deficiencies in said database;
storing records for a plurality of workers in said database;
for each deficiency in said plurality of deficiencies in said database, associating said deficiency with one category from said plurality of categories;
for each worker in said plurality of workers in said database, associating said worker with one or more categories and one or more locations and storing availability information for said worker in said database;
executing work order software on said central computer system;
creating a work order for one location from said plurality of locations using said work order software;
associating said work order with one of said deficiencies for said location;
automatically selecting one worker from said plurality of workers using said work order software,
said selection based on the location and category associated with said deficiency, the location and categories associated with said person and the availability information for said worker; and
electronically transmitting said work order to said worker.

21. The method as claimed in claim 20, further comprising:
storing records for a plurality of supervisors in said database;
for each supervisor in said plurality of supervisors in said database, associating said supervisor with one or more categories and one or more locations and storing availability information for said supervisor in said database;
creating a work order request using said work order software;
automatically selecting one supervisor from said plurality of supervisors using said work order software,
said selection based on the location and category associated with said work order request, the location and categories associated with said person and the availability information for said supervisor; and
transmitting said work order request to said supervisor;
approving said work order request using said work order software; and
wherein the step of creating a work order is based on said work order request.
